(19) United States
(12) Patent Application Publication
(10) Pub. No.: US 2006/0271885 A1
(43) Pub. Date: Nov. 30, 2006

(54) Automatic database entry and data format modification

(75) Inventors: Colin S. Pittendrigh, Bozeman, MT (US); Gary D. Orser, Bozeman, MT (US); Todd Byrne, Bozeman, MT (US)

Correspondence Address: KLARQUIST SPARKMAN, LLP, 121 SW SALMON STREET, SUITE 1600, PORTLAND, OR, 97204, US

(73) Assignee: Montana State University, Bozeman, MT (US)

(21) Appl. No.: 11/442,001

(22) Filed: May 25, 2006

Related U.S. Application Data
(60) Provisional application No. 60/684,544, filed on May 25, 2005.

(51) Int. Cl. G06F 7/00

(52) U.S. Cl. 715/856; 707/102

(57) ABSTRACT

A database can be constructed in which the data is stored as a data model structure, and a GUI definition is stored as a substantially mirror image of the data structure where portions of the structure have unique names and where different versions of the data model have similar names for semantically similar portions of the data model. The data model and the GUI definition can be combined to produce a display model data entry screen which can be used to enter data into the database. The GUI definition may lack data, but may also comprise a definition for a graphical object which will display the data. Adding fields to the display model data entry screen can automatically update the data model structure and the GUI definition. Earlier datasets generated using an original display model data entry screen can be automatically updated to reflect the new data model structure.

### CROSS REFERENCE TO RELATED APPLICATIONS

This application claims the benefit of U.S. Provisional Application No. 60/684,544, filed May 25, 2005. This application is incorporated herein in its entirety.

### STATEMENT OF RIGHTS TO INVENTIONS MADE UNDER FEDERALLY SPONSORED RESEARCH

This invention was partially made with government support under grant number 1R01MH6441601 from the National Institutes of Health (NIH). The U.S. Government has certain rights in this invention.

### COPYRIGHT AUTHORIZATION

A portion of the disclosure of this patent document contains material which is subject to copyright protection. The copyright owner has no objection to the facsimile reproduction by anyone of the patent disclosure, as it appears in the Patent and Trademark Office patent file or records, but otherwise reserves all copyright rights whatsoever.

### BACKGROUND

Databases can be considered a software architecture that combines the storage of regularly formatted and descriptively annotated data with a graphical user interface (GUI) to modify and retrieve the data. One major obstacle to more widespread use of database systems in general has historically been the difficulty in creating graphical user interfaces that day-to-day users of the data base need for interacting with the data. In most database systems both the organizational structure of the data and the GUI screens that interact with the data have to be designed and implemented separately.

Not surprisingly, a huge amount of software design effort has been directed toward the goal of automating the design and creation of databases. Some systems are more successful than others. One historical database-system design strategy is to restrict the complexity of the database so that the bindings between dynamically generated GUI components and the underlying data those GUI components refer to are easier to construct. There are serious limits to this strategy, however. Historically, if the low-level data organization was simple enough to allow automated data mappings to dynamically generated GUI components, as a consequence, the ability to model complex relationships in the data was lost. Moreover, systems that do support complex data modeling have not been able to support fully-automated GUI construction.

A second major limitation of traditional database systems is schema inflexibility. The schema is the logical organization of the database, including the types of data that can be held within the database and the relationships between the data. Historically, whenever a database schema was reorganized (perhaps to attain compatibility with an evolving or externally defined data description standard) three complex and highly manual programming steps were inescapably required.

First, the data structures that define the schema had to be redesigned and rewritten, by computer programmers often manually editing low-level computer program source code. Second, any and all GUI screens that interact with the data also had to be recoded, so event mapping between GUI and the underlying data was once again compatible. Third, all historical datasets had to be extracted from the old database, manually reorganized, and then reloaded into the new database, so the data could then be retrieved and manipulated according to the rules of the reorganized schema.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

A database can be created, wherein the database comprises creating a GUI screen to define the structure of a database; storing data entered using the GUI screen as a hierarchical data model with a structure; storing a GUI definition of the GUI screen as a GUI definition with a similar structure to the hierarchical data model; and combining the GUI definition and the hierarchical data model to generate a display model which allows entry of data into the database. The hierarchical data entity can comprise a root and named nodes, with respective named nodes in the hierarchical data entity having unique names. The unique names can comprise relationship paths through the hierarchical data entity.

In another aspect, successive versions of a data model representation of a database can be stored. Each data element within a version has a unique name, while each matching data element across different versions has an identical name. For at least some of the versions of the data model representation, a substantially mirror-image GUI definition is stored as well. Within this GUI definition, substantially all data elements in the data model have similarly-named elements in the GUI definition.

A data model creator can be built. This data model creator can create an acyclic and hierarchical data model. The system can also comprise a data namer which ensures that respective data location within a single instantiation of the data model have unique names and respective data locations within multiple instantiations of the data model have semantically equivalent names. The system further comprises a GUI definition creator which creates a GUI definition wherein the GUI definition substantially mirrors the data model; and a data model and GUI definition combiner which combines the data model and the GUI definition to create a combined display model.

The foregoing and other objects, features, and advantages of the invention will become more apparent from the following detailed description, which proceeds with reference to the accompanying figures.

### BRIEF DESCRIPTION OF THE DRAWINGS

FIG. 1A is a block diagram of an exemplary system for representing hierarchical data in both a data structure and a graphical user interface such that changes to the graphical user interface are automatically represented in the data structure.

FIG. 1B is a screenshot of an exemplary data entry screen.

FIG. 2 is a block diagram showing an exemplary mapping between a data model and its GUI definition.

FIG. 3 is a block diagram showing using default mapping rules to generate a display model for a data model when no GUI definition is present.

FIG. 4 is a diagram of an exemplary tree structure that can be used in embodiments disclosed within.

FIG. 5 is a block diagram showing an exemplary system for automatically modifying the underlying data of a database when a GUI input screen of the database is modified.

FIG. 6 is a block diagram showing an exemplary system which allows multiple GUIs to be used for the same data model which can be used with embodiments disclosed herein.

FIG. 7 is a flow diagram showing an exemplary GUI screen modification method.

FIG. 8A is a screen shot of an administrative screen which can be used to reorganize hierarchical data structure.

FIG. 8B is a flow diagram showing an exemplary data file update method.

FIG. 9 is a flowchart showing an exemplary method to create a combined display model.

FIG. 10 is a screen shot of a query editor which can be used with embodiments disclosed herein.

FIG. 11 is a block diagram of a computer system that can be used to implement automatic database entry and database format modification.

### DETAILED DESCRIPTION

### General Considerations

Disclosed below are representative embodiments of methods, apparatus, and systems having particular applicability to combining abstract interpreters that should not be construed as limiting in any way. Instead, the present disclosure is directed toward all novel and nonobvious features and aspects of the various disclosed methods, apparatus, and systems, and their equivalents, alone and in various combinations and subcombinations with one another. The disclosed technology is not limited to any specific aspect or feature, or combination thereof, nor do the disclosed methods, apparatus, and systems require that any one or more specific advantages be present or problems be solved.

### EXAMPLE 1

### Exemplary System for Automatically Updating Hierarchical Data

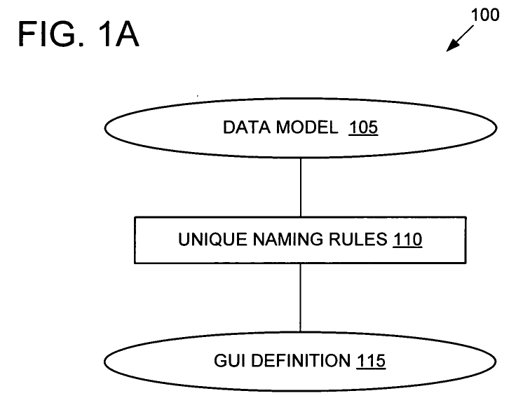

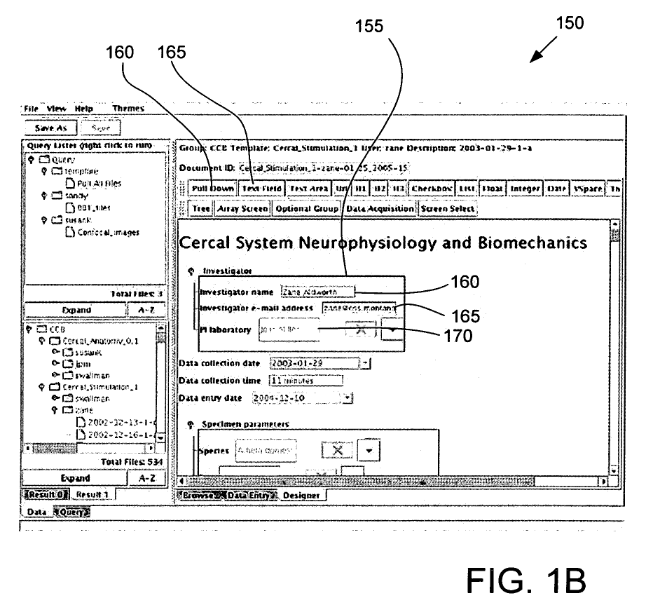

FIG. 1A shows an exemplary system 100 for creating a hierarchical database with matching entry screens. The system comprises a data model 105 and a GUI definition 115 both of which have similar structures, and both of which share unique naming rules 110 which allow nodes in both systems to be uniquely and unambiguously identified. This system allows the structure of the database to be altered by adding fields to or subtracting fields from an entry screen, such as the entry screen 150 shown in FIG. 1B.

An exemplary embodiment of the system includes a screen editor, which may be a GUI screen editor 150 (FIG. 1B), capable of entering data, retrieving data, or both. The GUI screen editor 150 may also be capable of adding new fields to the GUI. A sample new field may be if the Investigator area 155 had a new field, “Investigator phone number” added to it. In such a case, the system 100 would automatically reorganize all appropriate historical data, so that the data would be able to appear on the recently-modified data entry screen with the new field. This data update can require no other user intervention.

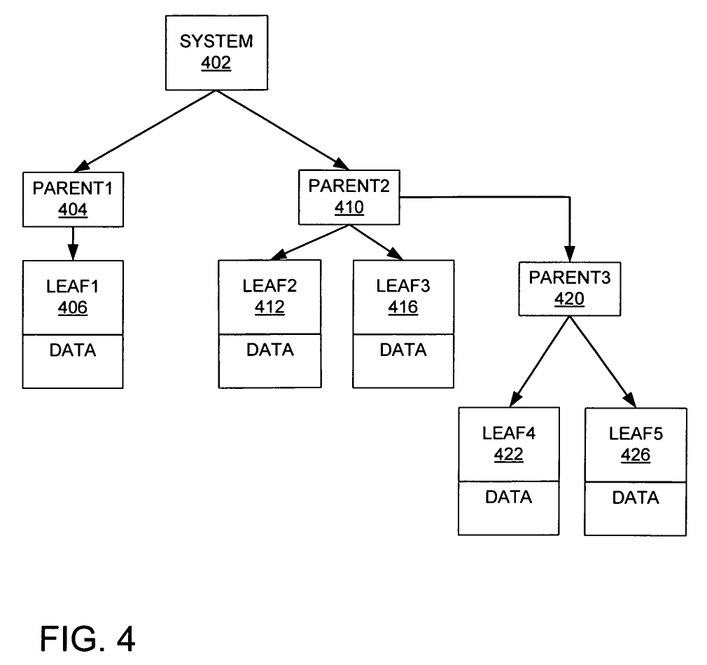

The data model 105 and the GUI definition 115 have at least one node-naming requirement. In an exemplary embodiment, the data model 105 comprises a series of data nodes (discussed more fully in connection with FIG. 4) with unique data naming rules 110. These rules 110 allow respective data node in the data model 105 to be uniquely and unambiguously identified. Also, semantically equivalent nodes are identifiable such that insert, update, and retrieval operations can be carried out over multiple nodes in multiple documents as a single transaction.

The data model 105 in this and other exemplary examples herein, can use any suitable database. The data model 105 in this and other exemplary examples herein can be in any appropriate computer language, including low level languages, such as assembly, traditional computer languages such as C, C++, FORTRAN, and the like, specific database languages such as SQL, languages used primarily in an Internet environment, such as the XML family of languages, and the like. Two such databases which can be used are Xindice and SleepyCat.

The format of the data storage can also be in any suitable form, such as in tables, a tree structure, or other suitable format.

The data itself can be of any number of forms, such as integer, character, real, some combination of the above, and so on.

The data model may have all data in a single file, may have different datasets of the data for the same model in different files and so on. In an exemplary embodiment, the data is stored as a series of documents, with respective individual instances of the data model being stored as a single document.

### EXAMPLE 2

### Exemplary Mapping between Data and GUI Structures

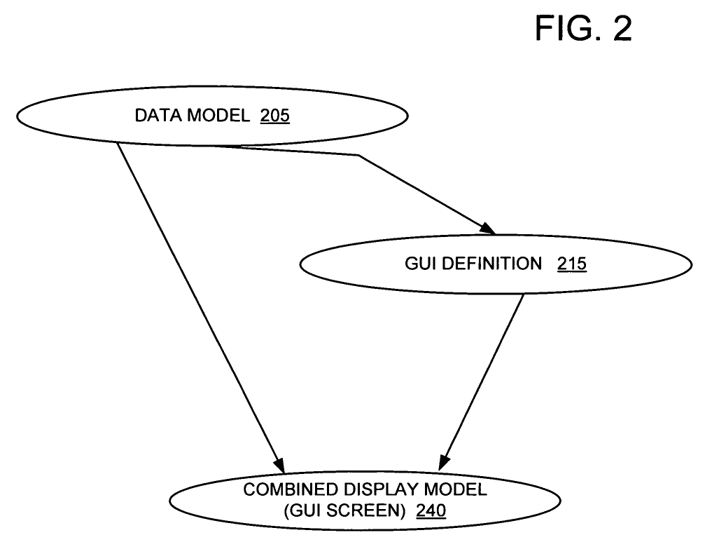

FIG. 2 shows and exemplary mapping between a data model 205 and a GUI definition 215 which are combined to produce a combined display model 240 which in an exemplary embodiment is a GUI screen which can be used to view, input, and modify both the data and the data structure. FIG. 1B shows such an exemplary combined display model.

For example, in an exemplary embodiment, the data model 205 is stored as a substantially non-cyclic, substantially hierarchical data model with labeled nodes. The GUI definition 215 is a substantially mirror image superset of the data model 205. Unlike the data model, the GUI definition has GUI component information which can be used to define the look of the graphical widget (radio buttons, check boxes, pull-down menus, and the like) which will display the data found in the corresponding data model 205 in the combined display model 240.

A system data tree could, for instance, be represented by a simple XML construct such as that shown in Table 1, below.

TABLE 1
Exemplary data model configuration

```
<The-System>
  <head>
    <gui>GUI_123</gui>
  </head>
  <body>
  <employee_1>
  <name datatype=”string”>John Doe</name>
  <phone datatype=”string”>123 456 789</phone>
  </employee_1>
  </body>
</The-System>
```

The corresponding GUI definitions can mirror-image supersets of their matching data trees, with the exception that the data is not included. So for example, the GUI tree definitions (Table 2) mirrors the hierarchical label=value structure of the matching data tree, with the individual nodes in the GUI tree also including abstract GUI component definitions which define how data found in the data model (Table 1) will be displayed. Table 2 has simple GUI display definitions, comprising a simple guitype. This is for illustration only. Other embodiments can include much fuller display information.

TABLE 2
Exemplary GUI definition

```
<The-System>
  <head>
    <gui>GUI_123</gui>
  </head>
  <body>
  <employee_1 guitype=”tree”>
  <name datatype=”string” guitype=”textbox”></name>
  <phone datatype=”string” guitype=”textbox”></phone>
  </employee_1>
  </body>
</The-System>
```

The GUI definition of table 2 is a mirror-image superset of the data definition, where the individual nodes comprise abstract GUI specifiers. In this exemplary embodiment, the GUI definition (such as the GUI definition 215) does not contain data values for nodes. So, for example, the data model container node “employee_{—}1” (Table 1) has a mirror image GUI definition node “employee_{—}1 guitype=“tree”. The data model leaf node “<phone datatype=“string”>123 456 789</phone>” has the corresponding mirror-image GUI definition “<phone datatype=”string” guitype=“textbox”></phone>.” The data model node and the GUI definition are combined to produce a single data input graphical widget in the combined display model GUI screen 240.

The data model (such as the data model 105 of FIG. 1) and GUI definitions (115 of FIG. 1) have node-naming rules. In such systems, respective data nodes in the data model 105 (FIG. 1) are uniquely and unambiguously identifiable. When data is arranged as a tree, as is shown with reference to example 4, nodes in the tree can be uniquely named using a node-name-path. The node-name-path is the concatenation of node names, from the root node of the tree down to the node in question, following the hierarchical path of parent/child relationships implicit in the structure of the tree. This naming schema requires that there be no duplicate node-name-paths in the tree.

Notice how both the data model configuration (in Table 1, above) and the GUI definition (in Table 2, above) have the same names for the same structures. As an example, the node-name-path to the “phone” node in Tables 1 and 2, above would be /The-System/body/employee_{—}1/phone.

### EXAMPLE 3

### Exemplary Mapping Using Default Mapping Rules

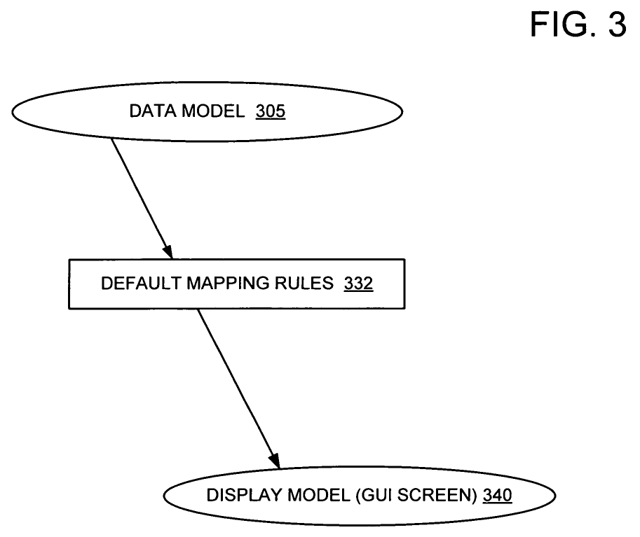

FIG. 3 shows how an exemplary data model 305 can produce a display model 340, such as to the display screen 150 (FIG. 1B) using default mapping rules 332 when a GUI definition, such as the GUI definition 215 is not present.

When the data model or a subset of the data model 305 is to be displayed, for example, as the return value from an interactive query, the data model 305, or a portion thereof, is retrieved from its underlying database. The data model 305 is then inspected to determine if a reference (such as a pointer) to a substantially matching GUI definition (such as the GUI definition 215) is present. If there is no such reference, then a display model data entry screen 340, which can be a dynamically constructed data entry screen, is constructed. This screen can be constructed using default mapping rules 332, which specify how the various data model constructs are mapped to displayable GUIs. Once a displayable GUI is created, then the GUI fields can be set to valid data values, such that the GUI can be initialized with appropriate data values for a new or ongoing interactive data session, perhaps to correct previous errors or omissions in a previous session, or to use as a default starting point for a new data entry session.

### EXAMPLE 4

### Exemplary Hierarchical Data Organization and Naming Scheme

The data, such as the data within a data model shown at 205 (FIG. 2) can be organized as a hierarchical, non-cyclic taxonomy of labeled data nodes, such as shown at 400 in FIG. 4. In an exemplary embodiment, the data is organized into a tree structure. Nodes in the tree can comprise either leaf-node data descriptors (labeled nodes that contain a value) or as labeled containers (parents) of other nodes. Each container node can consist of a label name only, such as the nodes 402, 404, 410 and 420. Each leaf node can comprise a label name and a matching data value, such as is shown at 406, 412, 416, 422, 426. Nodes that comprise labels alone are parent nodes that have corresponding child nodes, such as the parent nodes 404, 410, and 420. A leaf node is a node with no child nodes. Only leaf nodes have data associated with them. Each node in the tree has one and only one parent node, except for the root node of the tree, which has no parent. Nodes in the tree can comprise either leaf-node data descriptors (labeled nodes that contain a value) or as labeled containers (parents) of other nodes.

The leaf nodes in the tree will map, in a mirror-image GUI, to displayable widgets, which will be used to display the data in the tree. Respective GUI nodes will have the same name: a unique node-name-path as its matching data node. Because individual nodes (which will map to display items in a screen) can be automatically identified by their unique node-name-path, respective nodes can be used to represent unique semantic meanings in the data.

In an exemplary embodiment, two rules are used to name nodes. First, respective nodes (such as any of the nodes in FIG. 4) in any individual document can supply unambiguous identifiers that are unique to that individual document. Second, semantically equivalent nodes in other documents can be identified (in that document) by an identical identifier for respective documents.

Table 3, below, illustrates a syntactically well-formed and perfectly reasonable hierarchical construct that is not well suited for automated GUI processing:

TABLE 3
Hierarchical data not well suited for automated GUI processing.

```
<references>
  <book>
  <title>African Mammals</title>
  <author<John Doe</author>
    <chapter>
        <subject>Introduction</subject>
    </chapter>
    <chapter>
        <subject>Primates</subject>
    </chapter>
  </book>
  <book>
  <title>Birds of North America</title>
  <author>John Doe</author>
    <chapter>
        <subject>Introduction</subject>
    </chapter>
    <chapter>
        <subject>Raptors>/subject>
    </chapter>
  </book>
  </references>
```

If, for example, using the XML tree shown in Table 3, a user wanted to correct a previously entered data entry error, such that the author of ‘Birds of North America’ was ‘Mary Jane’ instead of ‘John Doe,’ there is no straightforward way for a computer program to know the second /references/book/chapter node is the right one to update.

However, the XML node-name-path to the author node of the second book description (/references/book/author) is identical to the node-name-path for multiple entries in the data.

TABLE 4
The same data from Table 3. with (slightly) modified node names that
exclude the possibility of duplicate node name paths.

```
<references>
  <book>
    <title>African Mammals</title>
  <book_1>
  <author<John Doe</author>
    <chapter_1>
        <subject>Introduction</subject>
    </chapter_1>
    <chapter_2>
        <subject>Primates</subject>
    </chapter_2>
  </book_1>
  <book_2>
  <title>Birds of North America</title>
  <author>John Doe</author>
    <chapter_1>
        <subject>Introduction</subject>
    </chapter_1>
    <chapter_2>
        <subject>Raptors>/subject>
    </chapter_2>
  </book_2>
  </references>
```

An exemplary system includes a computer program that inspects the structure of the second data fragment above, to dynamically construct an update statement that uniquely identifies a specific node, for example the node with the name “/references/book_{—}2/author/” as the correct node to update. A preferred embodiment uses unique node-name-paths to represent semantically unique meanings (nodes) in the data. Any underlying computer code that interacts with the data doesn't need to know what that semantically unique meaning is, it only needs to know that meaning exists, and that it can be uniquely referred to by its node-name-path.

An exemplary node naming scheme is as follows: at any container level (non-leaf, or internal node) in a data structure, such as that shown in FIG. 4, no individual node that is a child node of its containing parent can have an identifying not path shared by any other node. In Table 4, above, this is accomplished by disallowing duplicate and otherwise identical element names for any child of its containing node.

In an exemplary embodiment, for child nodes of the root node /references/ in Table 4, the node whose name is ‘book_{—}1’ is unique, among the collection of nodes that are first level children of the /references/ node. Further, the node path “/references/book_{—}1” in document A is identical to and considered similar to a “/references/book_{—}1” node in a document B. Identical node paths within any individual document are not allowed. However, identical node paths in different instantiations of the data model, such as in different XML documents, are allowed. Nodes with identical node paths in different documents are considered semantically equivalent.

In another exemplary embodiment, individual elements that have identical node names (as children at some particular container level in the tree, for example) can be identified by supplying an additional ‘id=X’ attribute to the node. This will also produce uniquely identifiable, semantically equivalent nodes.

TABLE 5
The same data from Table 4 with modified node name/node attribute
combinations

```
<references>
  <book id = “1”>
    <title>African Mammals</title>
  <author>John Doe</author>
    <chapter id = “1”>
        <subject>Introduction</subject>
    </chapter>
    <chapter id = “2”>
        <subject>Primates</subject>
    </chapter>
  </book>
  <book id = “2”>
  <title>Birds of North America</title>
  <author>John Doe</author>
    <chapter id = “1”>
        <subject>Introduction</subject>
    </chapter>
    <chapter id = “2”>
        <subject>Raptors>/subject>
    </chapter>
  </book>
  </references>
```

In the embodiment shown in Table 5, above, the concept of node equivalence across multiple documents is supported with unambiguous identification of equivalent nodes. Node paths can be constructed such that the naming procedure appears, but is not, ambiguous. For example, there are multiple nodes with the node-name path /references/book/chapter. However, each otherwise identical node-name-path is further identified with an id attribute that declares the specific node's sequential position as the child of its containing parents. Therefore, individual nodes are unambiguously identifiable, and node equivalence across multiple documents is preserved.

Regardless of the naming technique that is used, each non-leaf node can employ any node naming technique, for its first level children, but it should uniquely identify each first level child from the others, and the naming technique should also generate the same identifier for respectively semantically equivalent nodes in any other document, or data model instantiation.

TABLE 6
A document semantically equivalent to the document shown in Table 5.

```
<references>
  <book id = “1”>
    <title>Jellyfish of Antarctica</title>
  <author><Jane Doe</author>
    <chapter id = “1”>
        <subject>Cold Jellyfish </subject>
    </chapter>
    <chapter id = “2”>
        <subject>Iced Jellyfish</subject>
    </chapter>
  </book>
  <book id = “2”>
  <title>My Favorite Cetaceans</title>
  <author>Jane Doe</author>
    <chapter id = “1”>
        <subject>Whales</subject>
    </chapter>
    <chapter id = “2”>
        <subject>Dolphins>/subject>
    </chapter>
  </book>
  </references>
```

A semantically equivalent node is a node that is a member of a different dataset than the original node, but occupies the same location within the document. For example, Table 5 and Table 6 show the same data model being instantiated twice with different data. A semantically equivalent node across both instantiations is, for example, “author”, which, in both cases, has the path “references/author”, even though it has different data—“John Doe” in one case and “Jane Doe” in the other.

### EXAMPLE 5

### Exemplary Hierarchical Data Organization

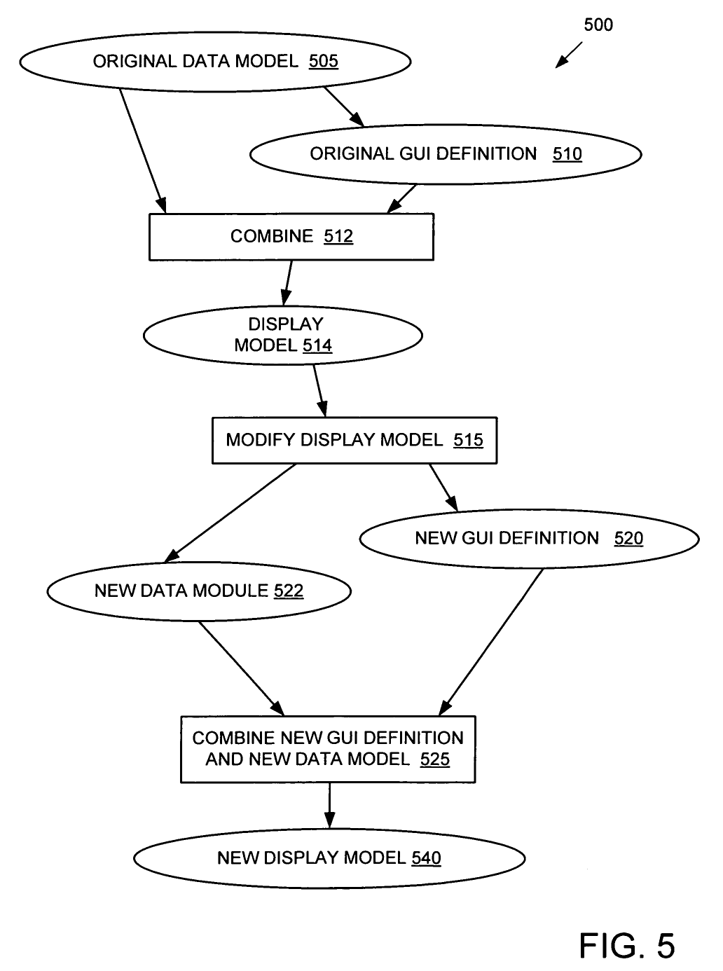

FIG. 5 shows an exemplary system for automatically modifying the underlying data of a database when a GUI input screen of the database is modified. The original data model 505 has an original GUI definition 510 that, preferably, was created in connection with the data model 505, either when the data model 505 was created, or at a later data, but associated with the data model 505. This can be a data entry screen, a data query screen, a combination of the two, or another appropriate database manipulation screen. At 512, the original data model 505 and the original GUI definition 510 are combined to produce a display model 514 which can be used to enter or to modify data within the data model 505.

At 515, the original GUI definition is modified. In an exemplary embodiment, working with a GUI editor, users can interactively create data entry sub-menus from a list of interactive menu types. Some menu types, such as text boxes, pull-down menus or file selection browsers represent leaf-level nodes (such as 406 in FIG. 4) in a hierarchical tree of meta data descriptors. Other menu types can represent containers which can recursively enclose other menus. Standard drag-and-drop techniques can be used to move menu items into and out of various container objects such that an arbitrarily complex tree of interactive data description menus can be created.

Once satisfied with the structure of any newly created data entry screen (or screens) the user can save the screen for subsequent use. Any such interactively constructed data entry screen can then save itself as a nested tree of label, value pairs in whatever database format is being used. When the user performs the save, or shortly thereafter, the new GUI definition 520 is automatically created. At 522 a new data model is also automatically generated.

At 525, the new GUI definition 520 is combined with the new data model 522 to produce a new display model 540. The user can then use the new display model 540 to enter new data, make more modifications to the date and/or GUI structure, and so forth.

The previous GUI definition 515 is not deleted, in an exemplary embodiment, and can still be used with the new data model 530 to view and enter data. Therefore, previously defined GUI screens can be reinstantiated and then populated with historical data as chosen by a user. This makes it possible to log into an unfinished data entry session and finish up using the original data entry screen, even if the data has since been modified. It is also possible to initiate a new data entry session with a reasonable set of default values.

### EXAMPLE 6

### Exemplary Multiple GUI and Historical Data Models

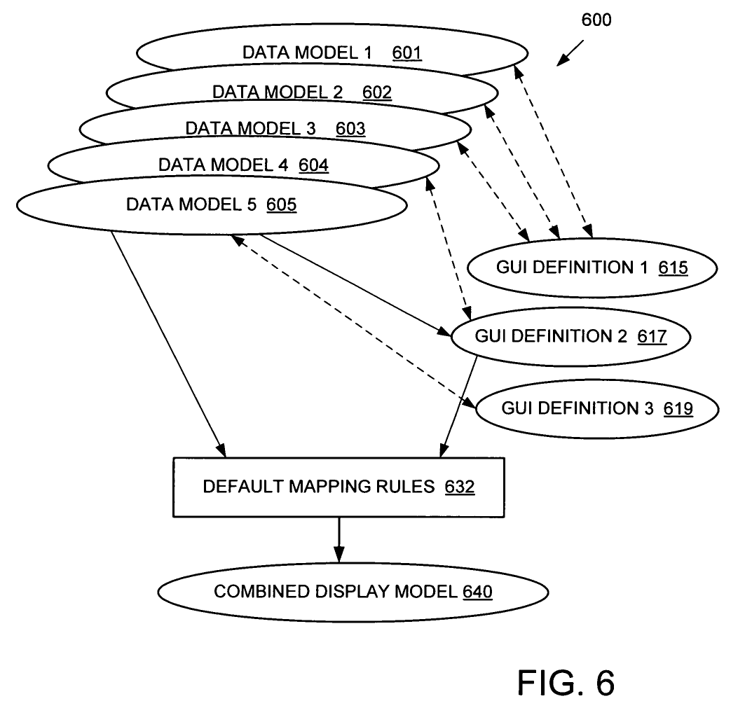

FIG. 6 shows an exemplary system which allows multiple GUIs to be used with multiple versions of the same basic data model. It shows a data model 605 and its historical data files (or instantiations) 604, 603, 602, and 601. Data models 601, 602 and 603 were created in conjunction with GUI definition 1615. GUI definition 2 was created by modifying a combined display model which was created from data model 3 603 and GUI definition 1615. Data model 604 was created in conjunction with a combined display model that was created using GUI definition 2617 and data model 4 604.

It is common for a data model to go through an iterative design process. That is, a first data structure and screen (GUI definition 615) is created, and then it is used—that is, multiple data models are created 601, 602, 603 using a specific GUI definition screen, such as GUI definition screen 615. This is indicated in FIG. 6 by the dotted lines connecting the specific data model and GUI definition, such that data model 603 was created, for example, using GUI definition 2617.

During use it is often discovered that it would be very helpful to change the data or the display in some way. For example, it might be useful to have another data item in the database. To add the new item, a new GUI definition 617 is created with a new display widget (such as an input box, drop-down menu or the like) used to add the data. Making this change to the GUI definition then creates an updated data model associated with that specific GUI definition. At a later date, the display model data entry screen (which is a combination of a specific data model and GUI definition) is changed again, which leads to a similar, but distinct GUI definition 619. The display model data entry screen that is generated from GUI definitions 615, 617, 619 can be combined with any of the data models 610, 602, 603, 604, 605 to produce a combined display model 640 which can the be used for user data input, modification, and so forth.

For example, as shown, the data model 605, produced using the data input screen associated with the GUI definition 619, can be combined with the data entry screen associated with the earlier GUI definition 617, to produce the combined display model data entry screen 640. If the data model 605 has data fields that are not defined in the earlier GUI definition 617 then the data fields can be created on the associated combined data model data entry screen 640 using default mapping rules 632, or such data fields can be not shown on the combined data model data entry screen 640 associated with the GUI definition 617.

At least a portion of each data model 601-605 maps to at least a portion of each GUI definition 615-619, where the mapping comprises data structures (such as nodes) having substantially identical names across data model instantiations if there is a mapping. If there is no mapping between a structure of the data model 601-605 and the GUI definition 615-619, then the missing structure has been either added or deleted, and so can be handled using default mapping rules 632.

### EXAMPLE 7

### Exemplary GUI Screen Editor Modification Method

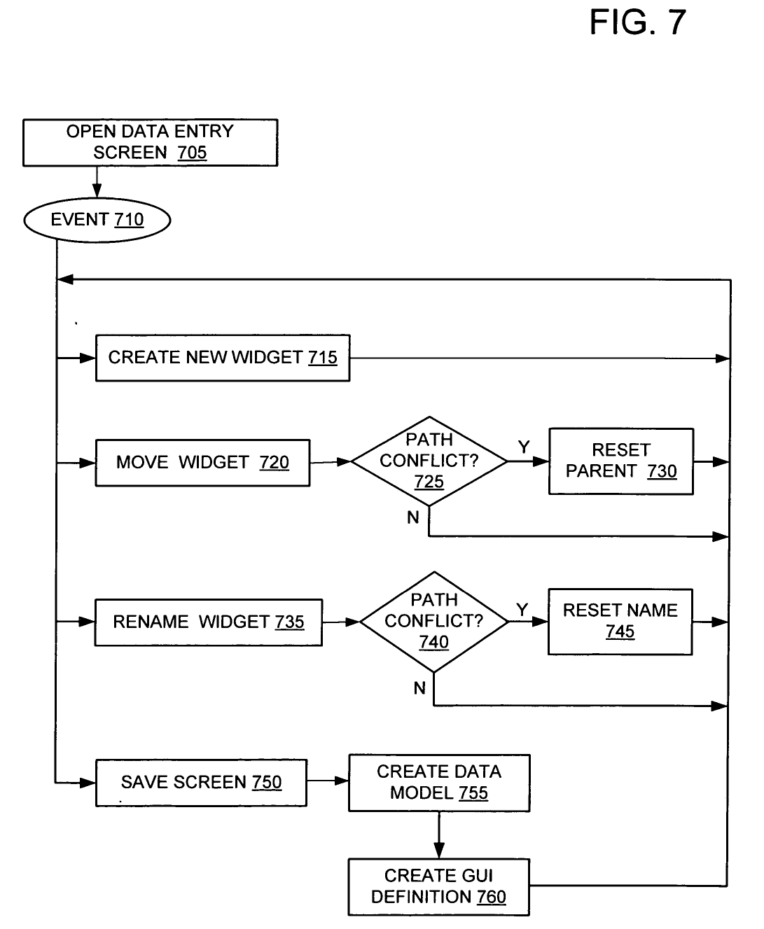

FIG. 7 shows an exemplary method to change the schema of a database by modifying a related data entry screen. This method can be performed, for example, by the software 1180 of the computing environment 1100 in FIG. 1. At 705 a data entry screen is opened, which can be a combined display model, such as that discussed with reference to FIG. 2. This data entry screen may be opened by first combining a data model, such as the data model 205, with a matching mirror image GUI definition, such as the GUI definition 215 of FIG. 2. This can produce a combined display model 240 (FIG. 2) which can be a data entry screen such as the data entry screen 150 of FIG. 1B.

At 710, an event occurs which modifies the data entry screen.

At 715, the event is the creation of a new widget. An exemplary data entry screen comprises a selectable list of widgets such as the pull down button 160 (FIG. 1B) and the text field button 165 (FIG. 1B). Other sorts of widgets such as URL types, number types, which require numeric data and the like can also be provided. When the widget of the appropriate type is created, the parent of the new widget is set to “root” such as the root node “System” 402 of FIG. 4A. Two distinct types of widgets can be created, data widgets, and container widgets. Data widgets are items which represent data, and which can be stored as leaf nodes with a value such as the leaf nodes 406, 412, 416, 422, and 426 of FIG. 4. Container widgets are items which do not represent data, and which can contain other widgets, such as the system node 402 and the parent nodes 404, 410, 420 of FIG. 4. The Investigator box 155 (FIG. 1B) can be thought of as a container widget, which holds the data widgets “Investigator's name” 160 (FIG. 1B), “Investigator's e-mail address” 165 (FIG. 1B) and “P1 Laboratory” 170 (FIG. 1B).

At 720 an event is received that indicates that a widget has been moved. There is a potential for being a path conflict, when widgets are moved, if the moved widget has the same path name as a previously-existing widget. For example, if a widget named “phone” were moved to be a child of the container widget “employee_{—}1” in Table 1, then a conflict would exist, as there is already a widget with the name “phone.” At 725, if there is a path conflict then the process continues at 730 where the parent is reset to a value which does not produce a conflict.

At 735 an event indicating that a widget has been renamed is received. At 740 it is determined if there is a path conflict. If the widget is given a name which makes the widget share a name with an existing widget, then there is a path conflict and at 745 the widget is renamed, which may comprise the widget being reset to a known name which does not create a path conflict. The process then resumes at 710.

At 750 a save screen event is received. Originally, the data model and matching GUI definition were combined to create the data entry screen. Here, the reverse process happens. At 755, a hierarchical data structure is created and saved using, at a minimum, the data entry information displayed within the data entry screen. At 760, a matching hierarchical GUI definition that mirrors the saved data structure is created and saved.

### EXAMPLE 8

### Exemplary Data Update Method

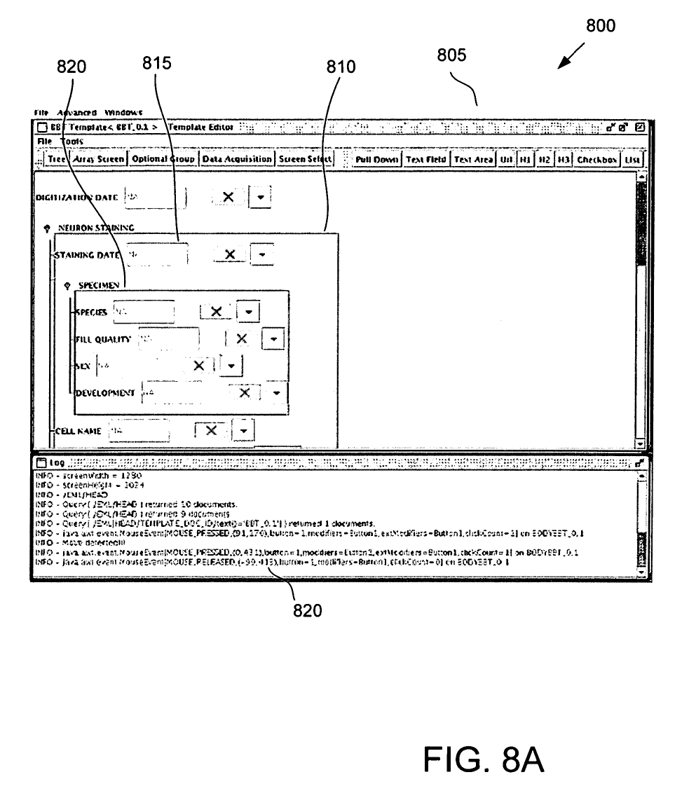

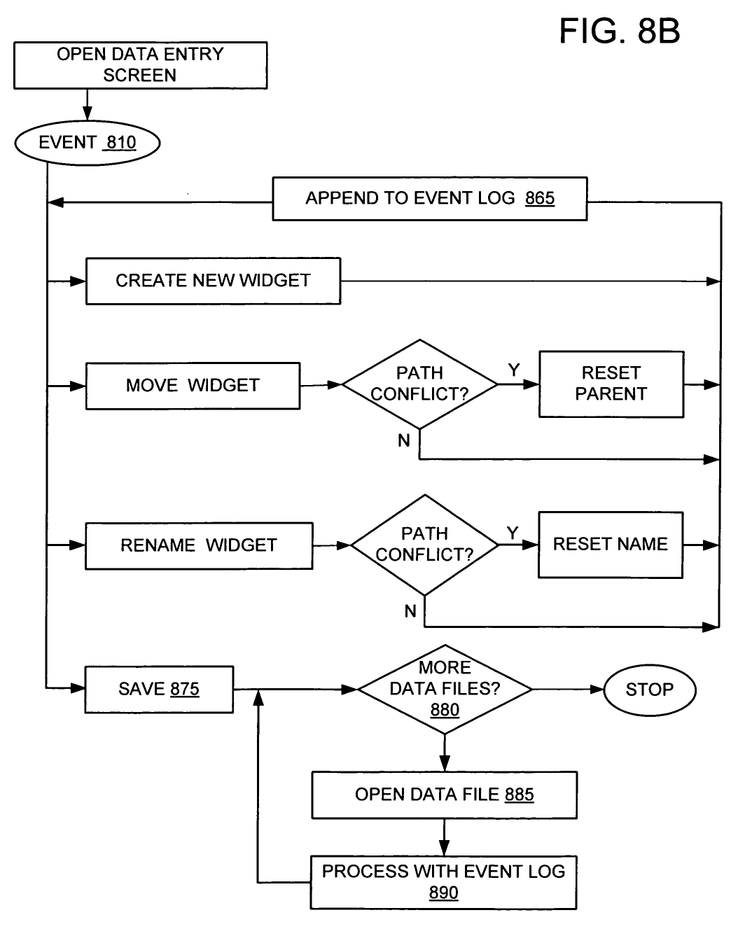

FIG. 8A shows an exemplary screen shot of an administrative screen 800 which can be used to systematically modify a GUI and any historical data created by the original GUI. The hierarchical structure of the underlying data can be visually presented by physically labeling container objects (described with reference to example 4) as boxes which enclose their child objects. For example, “neuron staining” 810 can be seen to be a container object which itself contains, among other items, the leaf node “staining date” 815, and a container object “specimen” 820. Listings in a log file can be seen at 820.

This administrative screen 800 may require special permission to access, as it can be used to modify large amounts of data.

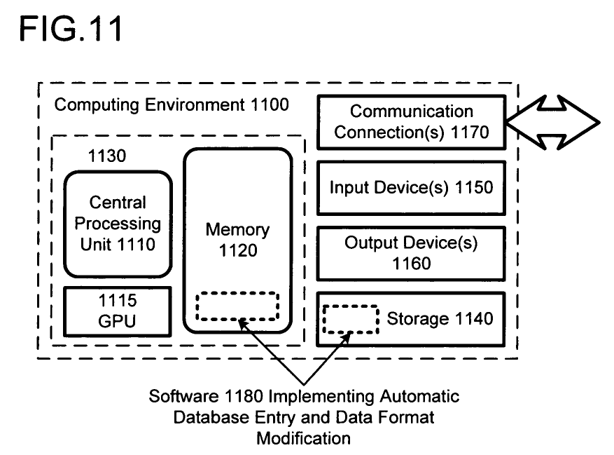

FIG. 8B shows an exemplary method to update historical data when the GUI which was used to initially enter the data is modified. The method shown at FIG. 8B is quite similar to that shown in FIG. 7, with a few differences. This method can be performed, for example, by the software 1180 of the computing environment 1100 in FIG. 11. At 810, an event occurs. The event can be, among others, creating new data fields, moving existing data fields, or even if the database is hierarchical, rearranging the data hierarchy structure. At 865, once an event has successfully occurred, the event is appended to a log file. By reproducing the events indicated in the log file a different dataset entered with the same entry screen can be automatically updated.

Once a user is satisfied with the new entry screen, at process block 875 the screen, including the log file, is saved. In an exemplary embodiment, the log file is preprocessed such that if a single item has multiple similar actions only the ones that affect the final status are saved. For example, if a widget is renamed three times, only the third and final naming counts. Thus, the first two names will not be placed in the processed log file. In another embodiment, no log file preprocessing takes place.

At 880, it is checked if there is at least another data model file which is a different instantiation of the same data file. Examples of such data model files are the historical data models 601-605. If so, then at 885 the data model file is opened, and at 890 the data file is automatically processed using the log file to produce a data model file which can be used with the newly-updated GUI screen. This opening and updating process continues until appropriate data model files have been modified. I In some embodiments only data model files that were created with or prior to the currently-modified GUI definition are updated. In other embodiments, the user can choose which data model files to update.

### EXAMPLE 9

### Exemplary Method to Create a Combined Display Model

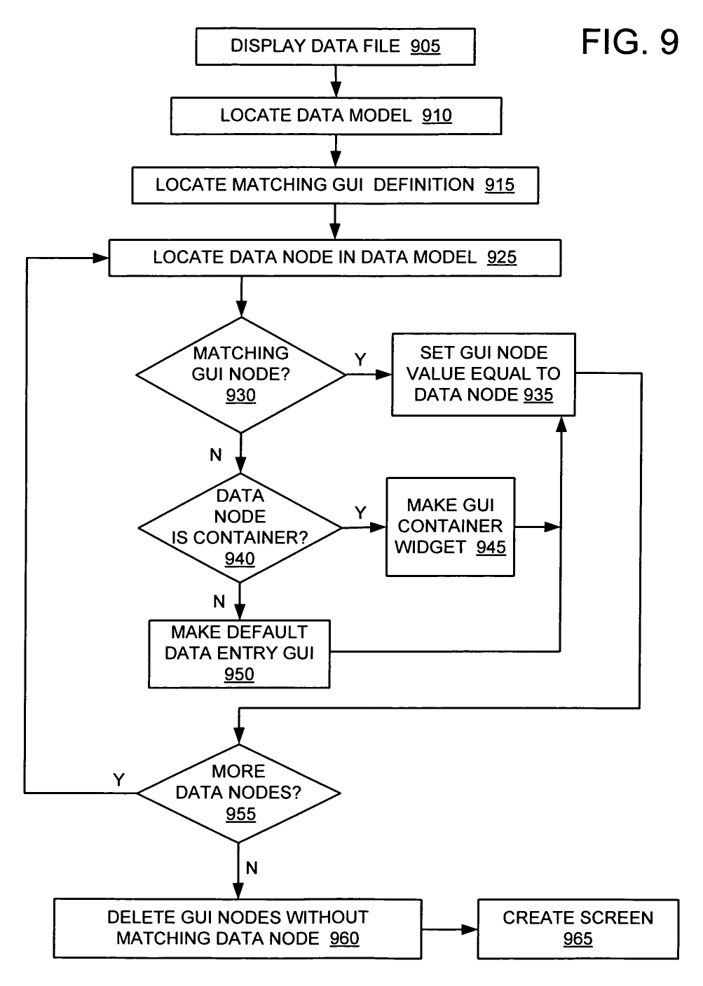

FIG. 9 shows an exemplary method to create a combined display model, such as the combined display model 240 (FIG. 2) using a data model 205 (FIG. 2) and a GUI definition, such as the GUI definition 215 (FIG. 2). This method can be performed, for example, by the software 1180 of the computing environment 1100 in FIG. 11. At 905, the display model data file is displayed. In alternate embodiments, the display model is chosen, but not physically displayed. At 910, the data model associated with the display model is located. At 915 a GUI definition, which may be a GUI definition 215 (FIG. 2) associated with the data model 910 is located 915.

At 925 a single data node in the data model is located. (Other embodiments may locate multiple nodes at a time.) At 930 it is checked if there is a matching GUI node. If so, then the GUI node is set to the value of the data node. The GUI node may also have other display information, such as type of display, location for display, colors, size, etc. That information is gathered here. The GUI may be rendered now, or may be rendered after all GUI nodes have been located. The process then continues at 955.

If there is no matching GUI node, then at decision block 940, it is determined if the data node is a container. If so, then at 945, a default GUI container is created, in some embodiments, using default mapping rules 332 (FIG. 3). The process continues at 935. If not, then at 950 a default data entry menu item is created (also possibly using default mapping rules 332), and the process continues at 955.

At decision block 955, it is checked if there are more data nodes. If so, the process continues at process block 925. If not, the process continues at process block 960. At optional process block 960, it is checked if there are any leftover GUI nodes which do not have corresponding data nodes. If so, then the orphan GUI nodes are deleted. Then, at 960, a data entry GUI screen is created.

### EXAMPLE 10

### Exemplary Screen Shot of a Query Editor

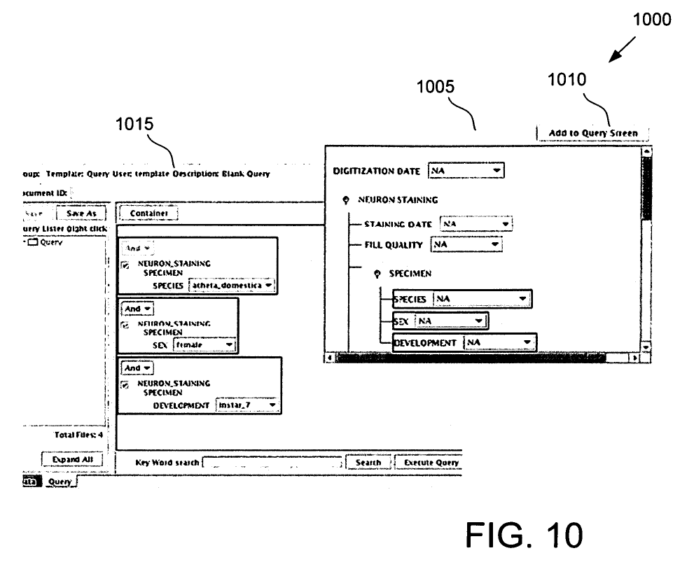

FIG. 10 at 1000 shows an exemplary screen shot of a query editor which can be used in conjunction with disclosed embodiments. To build a data query screen, a query editor can begin by instantiating a version of the original data entry screen used to enter the data for the given dataset. This data entry screen can be a combined display model, such as is shown at 240 in FIG. 2. Such a screen is shown at 1005. Items from this screen 1005 can be added to a query screen 1015. To add items to the query screen 1015, the user can select an item, with, for example, a mouse click. Then, selecting the “Add to Query Screen” button 1010 will add the selected item to a query screen 1015.

In other embodiments, items from the data entry screen can be dragged to the query screen. When an item is added to the query screen, the original item, for example, a data widget, is transformed into its corresponding query widget. In an exemplary embodiment, a dynamically generated query menu is created whose name matches the name of the data node it was created from. Internally, the representation of the query menu is initialized with a chooseable comparison operator and a copy of the unique node name of the matching data node. As additional query terms are added to the query screen 1015, a query is built with substantially all container object representing logical parentheses in a query statement. When the user has constructed the desired query, as reflected in the query screen 1015, a functional query interface is automatically constructed and saved for subsequent use.

When the user runs the query, the query statement can be translated into a specific query written in the language of the underlying database. The query is then run, and the results are reported. The reported results may be sent to a file, may be displayed using the original query screen 1015, or may be displayed in a different fashion.

### EXAMPLE 11

### Computing Environment

FIG. 11 and the following discussion are intended to provide a brief, general description of an exemplary computing environment in which the disclosed technology may be implemented. For instance, any of the functionalities described with respect to creating or using an automatically modifiable database GUI and structure in FIG. 11 can be implemented in such a computing environment. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

FIG. 11 illustrates a generalized example of a suitable computing environment 1100 in which described embodiments may be implemented. The computing environment 1100 is not intended to suggest any limitation as to scope of use or functionality of the invention, as the present invention may be implemented in diverse general-purpose or special-purpose computing environments.

With reference to FIG. 11, the computing environment 1100 includes at least one central processing unit 1110 and memory 1120. In FIG. 11, this most basic configuration 1130 is included within a dashed line. The central processing unit 1110 executes computer-executable instructions and may be a real or a virtual processor. The environment 1100 further includes the graphics processing unit GPU at 1115 for executing such computer graphics operations as vertex mapping, pixel processing, rendering, and texture mapping. In a multi-processing system, multiple processing units execute computer-executable instructions to increase processing power and as such the GPU and CPU can be running simultaneously. The memory 1120 may be volatile memory (e.g., registers, cache, RAM), non-volatile memory (e.g., ROM, EEPROM, flash memory, etc.), or some combination of the two. The memory 1120 stores software 1180 implementing the described methods of automatic database entry and data format modification.

A computing environment may have additional features. For example, the computing environment 1100 includes storage 1140, one or more input devices 1150, one or more output devices 1160, and one or more communication connections 1170. An interconnection mechanism (not shown) such as a bus, controller, or network interconnects the components of the computing environment 1100. Typically, operating system software (not shown) provides an operating environment for other software executing in the computing environment 1100, and coordinates activities of the components of the computing environment 1100.

The storage 1140 may be removable or non-removable, and includes magnetic disks, magnetic tapes or cassettes, CD-ROMs, CD-RWs, DVDs, or any other medium which can be used to store information and which can be accessed within the computing environment 1100. The storage 1140 stores instructions for the software 1180 to implement methods of automatic database entry and data format modification.

The input device(s) 1150 may be a touch input device such as a keyboard, mouse, pen, or trackball, a voice input device, a scanning device, touchscreen, or another device that provides input to the computing environment 1100. For audio, the input device(s) 1150 may be a sound card or similar device that accepts audio input in analog or digital form, or a CD-ROM reader that provides audio samples to the computing environment. The output device(s) 1160 may be a display, printer, speaker, CD-writer, or another device that provides output from the computing environment 1100.

The communication connection(s) 1170 enable communication over a communication medium to another computing entity. The communication medium conveys information such as computer-executable instructions, compressed graphics information, or other data in a modulated data signal. These connections may include network connections, which may be wireless connections, may include dial-up connections, and so on. The other computing entity may be a portable communications device such as a wireless handheld device, a cell phone device, and so on.

Computer-readable media are any available tangible media that can be accessed within a computing environment. By way of example, and not limitation, with the computing environment 1100, computer-readable media include memory 1120, storage 1140, communication media, and combinations of any of the above.

Moreover, any of the methods, apparatus, and systems described herein can be used in conjunction with combining abstract interpreters in a wide variety of contexts.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine” and “identify” to describe the disclosed technology. These terms are high-level abstractions of the actual operations that are performed. The actual operations that correspond to these terms will vary depending on the particular implementation and are readily discernible by one of ordinary skill in the art.

Further, data produced from any of the disclosed methods can be created, updated, or stored on tangible computer-readable media (e.g., tangible computer-readable media, such as one or more CDs, volatile memory components (such as DRAM or SRAM), or nonvolatile memory components (such as hard drives)) using a variety of different data structures or formats. Such data can be created or updated at a local computer or over a network (e.g., by a server computer).

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-enabled method of creating a database comprising:
responding to an input sequence associated with the creation of a GUI screen which defines the structure of the database;
storing a data model of the GUI screen;
storing a GUI definition of the GUI screen, the GUI definition having a similar structure to the data model; and
combining the GUI definition and the data model to regenerate the GUI screen which allows entry of data into the database.

2. The method of claim 1 wherein the data model and the GUI definition are tree structures with nodes and wherein respective data model nodes have corresponding GUI definition nodes.

3. The method of claim 1 wherein the data model and the GUI definition have a substantially mirror-image structure, and wherein respective data module structural items have the same name as their corresponding GUI definition structural items.

4. The method of claim 1 wherein the data model comprises a root and named nodes, wherein respective named nodes in the data model have unique names and wherein the unique names comprise relationship paths through the data model.

5. The method of claim 4 wherein the relationship path begins at the root of the data model and ends at the named node.

6. The method of claim 1 further comprising historical data sets associated with the data model and wherein combining the GUI definition and the data model further comprises automatically updating at least one historical data set such that the historical data set can be used with the GUI definition to regenerate the GUI screen.

7. The method of claim 1 further comprising:
responding to an input sequence associated with the modification of a GUI screen; and
recording the modification in a log file.

8. The method of claim 7 further comprising:
using the log file to modify at least one historical data set associated with the GUI screen prior to modification such that the historical data set can be used with the GUI screen after modification.

9. A computer-enabled method comprising:
Storing successive versions of a data model representation of a database wherein each data structure within a version has a unique name and wherein each matching data structure in different versions has an identical name; and
for at least some versions of the data model representation, storing a substantially mirror-image GUI definition; wherein substantially all data structures in the data model have similarly-named structures in the GUI definition.

10. The computer-enabled method of claim 9 wherein the data model is represented by a tree with a root and nodes and wherein the name of a specific node comprises the hierarchical path from the root to the specific node.

11. The computer-enabled method of claim 10 wherein at least one version of the data model can be combined with at least one version of the GUI definition to produce a GUI entry screen.

12. The computer-enabled method of claim 1 wherein substantially any GUI definition can be combined with substantially any data model to produce a GUI entry screen.

13. A system comprising:
a data model creator which creates a data model, wherein the data model is acyclic and hierarchical;
a data namer which ensures that a respective data location within a single instantiation of the data model have unique names and wherein respective data locations within multiple instantiations of the data model have semantically equivalent names;
a GUI definition creator which creates a GUI definition wherein the GUI definition substantially mirrors the data model; and
a data model and GUI definition combiner which combines the data model and the GUI definition to create a combined display model.

14. The system of claim 13 further comprising a historical data modifier which propagates changes to the data model throughout earlier versions of data model data.

15. A computer-enabled method to update data files comprising:
opening a previously-created data entry screen, the data entry screen having multiple historical data files associated with it;
responding to a modification of the data entry screen by a user;
saving the modified data entry screen; and
automatically updating at least one historical data file associated with the data entry screen such that the historical data file can be used by the data entry screen without further modification.

16. The computer-enabled method of claim 15 wherein responding to a modification of the data entry screen by a user comprises keeping a record of the modification in a log file.

17. The computer-enabled method of claim 15 wherein the automatic updating comprises using the log file to automatically update the historical data file.

18. A computer-readable medium having computer-executable instructions for performing the method recited in claim 15.

19. A computer-enabled method of producing an automatically-updatable database comprising
using a data file comprising a database with a structure and a GUI definition which is a substantially mirror image of the data file to create a combined display model screen,
responding to input sequence which indicates that the combined display model screen has been modified to specify a change in the database structure; and
automatically recording the modification to the database structure in an updated data file and an updated mirror image GUI definition.

20. A computer-readable medium having computer-executable instructions for performing the method recited in claim 19.
